(19) United States
(12) Patent Application Publication
(10) Pub. No.: US 2007/0115220 A1
(43) Pub. Date: May 24, 2007

(54) Plasma display apparatus

(75) Inventor: Jeong Pil Choi, Suwon-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/603,143

(22) Filed: Nov. 22, 2006

(30) Foreign Application Priority Data
Nov. 23, 2005 (KR) 10-2005-0112565

(51) Int. Cl. G09G 3/28

(52) U.S. Cl. 345/68

(57) ABSTRACT

A plasma display apparatus is disclosed. The plasma display apparatus includes a plasma display panel, and an energy recovery circuit that supplies an energy to the plasma display panel using one inductor and recovers an energy from the plasma display panel using a plurality of inductors. Inductance in an energy supply path for supplying the energy to the plasma display panel is less than inductance in an energy recovery path for recovering the energy from the plasma display panel.

This Nonprovisional application claims priority under 35 U.S.C. § 119(a) on Patent Application No. 10-2005-0112565 filed in Korea on Nov. 23, 2005 the entire contents of which are hereby incorporated by reference.

### BACKGROUND

1. Field

This document relates to a display apparatus, and more particularly, to a plasma display apparatus.

2. Description of the Related Art

Out of display apparatuses, a plasma display apparatus comprises a plasma display panel and a driver for driving the plasma display panel.

The plasma display panel has the structure in which barrier ribs formed between a front panel and a rear panel forms unit discharge cell or discharge cells. Each discharge cell is filled with an inert gas containing a main discharge gas such as neon (Ne), helium (He) and a mixture of Ne and He, and a small amount of xenon (Xe).

The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

The related art plasma display panel requires a high voltage of several hundreds of volts in the generation of an address discharge and a sustain discharge. Accordingly, it is necessary to reduce a driving voltage. For this, a driving circuit generally adopts an energy recovery circuit.

The energy recovery circuit recovers charges accumulated on scan electrode lines and sustain electrode lines and charges accumulated on address electrode lines, thereby reusing the recovered charges in a next discharge.

However, since the related art energy recovery circuit uses the same inductor in an energy recovery operation and an energy supply operation of the related art energy recovery circuit, the discharge efficiency is reduced.

### SUMMARY

In one aspect, a plasma display apparatus comprises a plasma display panel, and an energy recovery circuit that supplies an energy to the plasma display panel and recovers an energy from the plasma display panel, wherein inductance in an energy supply path for supplying the energy to the plasma display panel is less than inductance in an energy recovery path for recovering the energy from the plasma display panel.

In another aspect, a plasma display apparatus comprises a plasma display panel, a source capacitor charged to an energy recovered from the plasma display panel, an energy supply controller forming an energy supply path for supplying an energy to the plasma display panel, an energy recovery controller forming an energy recovery path for recovering an energy from the plasma display panel, a first inductor connected between the energy recovery controller and the source capacitor, and a second inductor connected between a common terminal of the energy supply controller and the energy recovery controller and the plasma display panel.

In still another aspect, a plasma display apparatus comprises a plasma display panel, and an energy recovery circuit that supplies an energy to the plasma display panel using one inductor and recovers an energy from the plasma display panel using a plurality of inductors.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 is an exploded perspective view of the structure of a plasma display panel of a plasma display apparatus according to embodiments;

FIG. 2 is a plane view of the disposition structure of each of an electrode line and a discharge cell in the plasma display panel of FIG. 1;

FIG. 3 illustrates an energy recovery circuit of a plasma display apparatus according to a first embodiment;

FIG. 4 illustrates a driving waveform generated by the energy recovery circuit of the plasma display apparatus according to the first embodiment;

FIG. 5 illustrates an energy recovery circuit of a plasma display apparatus according to a second embodiment;

FIG. 6 illustrates a driving waveform generated by the energy recovery circuit of the plasma display apparatus according to the second embodiment;

FIG. 7 illustrates an energy recovery circuit of a plasma display apparatus according to a third embodiment; and

FIG. 8 illustrates a driving waveform generated by the energy recovery circuit of the plasma display apparatus according to the third embodiment.

### DETAILED DESCRIPTION OF PREFERRED EMBODIMENTS

Reference will now be made in detail embodiments of the invention examples of which are illustrated in the accompanying drawings.

A plasma display apparatus comprises a plasma display panel, and an energy recovery circuit that supplies an energy to the plasma display panel and recovers an energy from the plasma display panel, wherein inductance in an energy supply path for supplying the energy to the plasma display panel is less than inductance in an energy recovery path for recovering the energy from the plasma display panel.

The energy recovery circuit may include a source capacitor charged to the energy recovered from the plasma display panel, an energy supply controller forming the energy supply path for supplying the energy to the plasma display panel, an energy recovery controller forming the energy recovery path for recovering the energy from the plasma display panel, a first inductor connected between the energy recovery controller and the source capacitor, and a second inductor connected between a common terminal of the energy supply controller and the energy recovery controller and the plasma display panel.

The energy supply path may pass through the source capacitor, the energy supply controller, and the second inductor.

The energy recovery path may pass through the second inductor, the energy recovery controller, the first inductor, and the source capacitor.

The energy recovery circuit may further include a first clamping diode connected between a common terminal of the second inductor and the energy supply controller and a sustain voltage source.

The energy recovery circuit may further include a second clamping diode connected between the common terminal of the second inductor and the energy supply controller and a ground level voltage source.

A plasma display apparatus comprises a plasma display panel, a source capacitor charged to an energy recovered from the plasma display panel, an energy supply controller forming an energy supply path for supplying an energy to the plasma display panel, an energy recovery controller forming an energy recovery path for recovering an energy from the plasma display panel, a first inductor connected between the energy recovery controller and the source capacitor, and a second inductor connected between a common terminal of the energy supply controller and the energy recovery controller and the plasma display panel.

The energy supply controller may include a first switch and a first diode, and the energy recovery controller may include a second switch and a second diode.

The energy supply path may pass through the source capacitor, the energy supply controller, and the second inductor.

The energy recovery path may pass through the second inductor, the energy recovery controller, the first inductor, and the source capacitor.

The plasma display apparatus may further comprise a first clamping diode connected between a common terminal of the second inductor and the energy supply controller and a sustain voltage source.

The plasma display apparatus may further comprise a second clamping diode connected between the common terminal of the second inductor and the energy supply controller and a ground level voltage source.

A plasma display apparatus comprises a plasma display panel, and an energy recovery circuit that supplies an energy to the plasma display panel using one inductor and recovers an energy from the plasma display panel using a plurality of inductors.

An energy recovery path for recovering the energy from the plasma display panel may include a first inductor and a second inductor, and an energy supply path for supplying the energy to the plasma display panel may include the second inductor.

One terminal of the second inductor may be connected to the plasma display panel, and the energy recovery circuit may include a first clamping diode connected between the other terminal of the second inductor and a sustain voltage source.

The energy recovery circuit may further include a second clamping diode connected between the other terminal of the second inductor and a ground level voltage source.

Hereinafter, exemplary embodiments of the present invention will be described in detail with reference to the attached drawings.

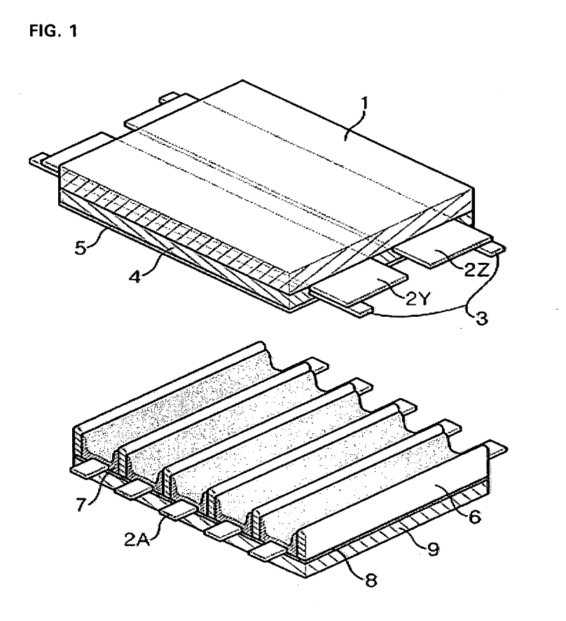

FIG. 1 is an exploded perspective view of the structure of a plasma display panel of a plasma display apparatus according to embodiments.

As illustrated in FIG. 1, each discharge cell includes a scan electrode 2Y and a sustain electrode 2Z formed on a front substrate 1, and an address electrode 2A formed on a rear substrate 9.

The scan electrode 2Y and the sustain electrode 2Z are generally made of an indium-tin-oxide (ITO) material. A bus electrode 3 made of a metal such as Cr is formed on the scan electrode 2Y and the sustain electrode 2Z to reduce a voltage drop caused by a high resistance of the ITO material.

On the front substrate 1 on which the scan electrode 2Y and the sustain electrode 2Z are formed in parallel, an upper dielectric layer 4 and a protective layer 5 are stacked. The protective layer 5 is generally made of MgO to prevent a damage to the upper dielectric layer 4 caused by sputtering generated when generating a plasma discharge and to increase a secondary electron emission coefficient.

On the rear substrate 9 on which the address electrode 2A is formed, a lower dielectric layer 8 and barrier ribs 6 are formed. A phosphor 7 is coated on the surface of the lower dielectric layer 8 and the surfaces of the barrier ribs 6. The address electrode 2A is formed in perpendicular to the scan electrode 2Y and the sustain electrode 2Z. The barrier ribs 6 are formed in parallel to the address electrode 2A. The barrier ribs 6 prevent ultraviolet rays and visible light generated by performing the plasma discharge from leaking into adjacent discharge cells.

Ultraviolet rays generated in the plasma discharge excite the phosphor 7 such that one of red (R) visible light, green (G) visible light or blue (B) visible light is generated Each of a plurality of discharge cells defined by the front substrate 1, the rear substrate 9, and the barrier ribs 6 is filled with a mixture gas of Ne and Xe and a penning gas for a gas discharge, and the like.

Discharge cells to be discharged are selected from the plurality of discharge cells having the above-described structure by performing an opposite discharge generated between the address electrode 2A and the scan electrode 2Y. Then, a discharge generated in the selected discharge cells is maintained by a surface discharge generated between the scan electrode 2Y and the sustain electrode 2Z.

Ultraviolet rays generated by performing a sustain discharge excite the phosphor 7 inside the discharge cells such that visible light is emitted from the discharge cells to the outside. As a result, the discharge cells control a duration of a discharge maintenance period such that a gray level is achieved. An image is displayed on the plasma display panel having the discharge cells, which are arranged in a matrix pattern.

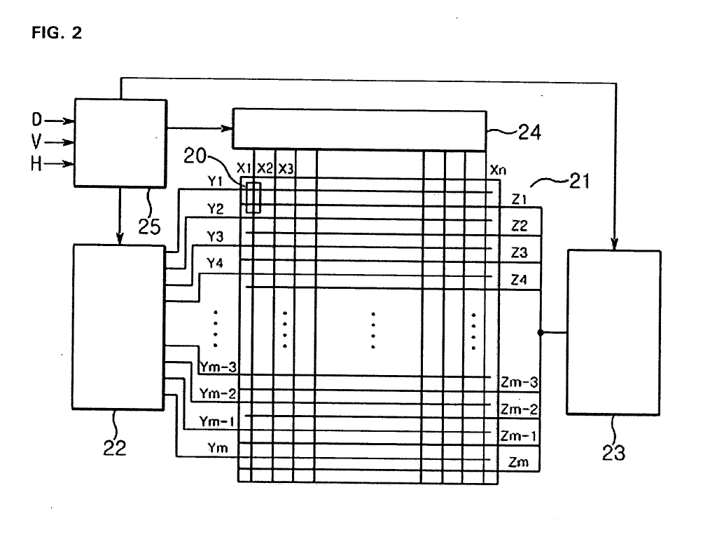

FIG. 2 is a plane view of the disposition structure of each of an electrode line and a discharge cell in the plasma display panel of FIG. 1.

As illustrated in FIG. 2, the plasma display apparatus according to the embodiments includes a plasma display panel 21, a scan driving circuit 22, a sustain driving circuit 23, an address driving circuit 24, and a control circuit 25. In the plasma display panel 21, m×n discharge cells 20 are arranged in a matrix pattern in which scan electrode lines Y1 to Ym, sustain electrode lines Z1 to Zm, and address electrode lines X1 to Xn are connected to one another inside each of the m×n discharge cells 20. The scan driving circuit 22 drives the scan electrode lines Y1 to Ym. The sustain driving circuit 23 drives the sustain electrode lines Z1 to Zm. The address driving circuit 24 drives the address electrode lines X1 to Xn. The control circuit 25 supplies each of the driving circuits 22, 23 and 24 a driving signal based on display data (D), a horizontal synchronization signal (H), a vertical synchronization signal (V), a clock signal, and the like, which are input from the outside.

The scan driving circuit 22 sequentially supplies a reset pulse, a scan pulse (or address pulse), and a sustain pulse to the scan electrode lines Y1 to Ym such that the m×n discharge cells 20 are sequentially scanned for each scan electrode line and a discharge in each of the m×n discharge cells 20 is maintained. The reset pulse uniforms initialization states of all the discharge cells, the scan pulse (or address pulse) selects cells to be discharged, and the sustain pulse represents a gray level in accordance with the number of discharges.

The sustain driving circuit 23 supplies a sustain pulse to all the sustain electrode lines Z1 to Zm, thereby generating a sustain discharge in the discharge cells selected by supplying the scan pulse. The scan driving circuit 22 and the sustain driving circuit 23 alternately supply the sustain pulse.

The address driving circuit 24 supplies an address pulse synchronized with the scan pulse supplied to the scan electrode lines Y1 to Ym to the address electrode lines X1 to Xn, thereby selecting cells to be discharged.

The plasma display panel thus driven requires a high voltage of several hundreds of volts in generating an address discharge and a sustain discharge.

Accordingly, it is necessary to reduce a driving voltage. For this, each of the scan driving circuit 22 and the sustain driving circuit 23 generally adopts an energy recovery circuit. Further, the address driving circuit 24 generally adopts an energy recovery circuit.

The energy recovery circuit recovers charges accumulated on the scan electrode lines Y1 to Ym and the sustain electrode lines Z1 to Zm and charges accumulated on the address electrode lines X1 to Xn, thereby reusing the recovered charges in a next discharge. An operation of the energy recovery circuit will be described in detail below.

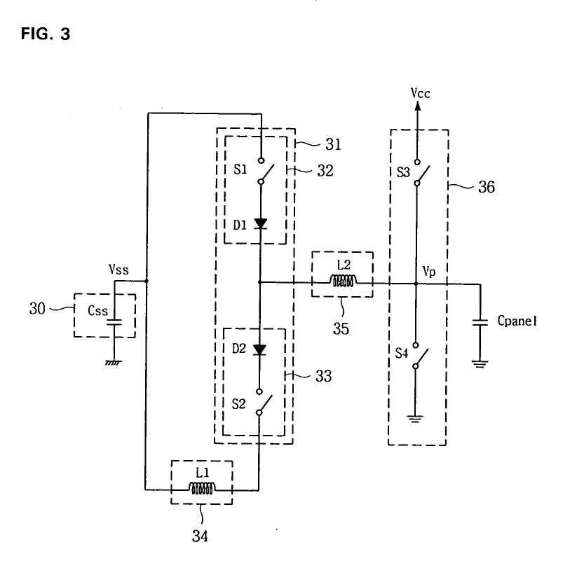

FIG. 3 illustrates an energy recovery circuit of a plasma display apparatus according to a first embodiment.

As illustrated in FIG. 3, the energy recovery circuit of the plasma display apparatus according to the first embodiment includes a source capacitor (Css) 30, an energy recovery/supply controller 31, a first inductor 34, a second inductor 35, and a sustain pulse supply controller 36.

One terminal of the source capacitor (Css) 30 is connected to a ground level voltage VGND, and the other terminal is commonly connected to one terminal of the first inductor 34 and one terminal of an energy supply controller 32 such that the source capacitor (Css) 30 is charged to energy recovered from a plasma display panel Cpanel.

The energy recovery/supply controller 31 includes the energy supply controller 32 and an energy recovery controller 33.

The energy supply controller 32 includes a first switch S1 and a first diode D1. The first switch S1 is turned on to perform an energy supply operation such that the energy supply controller 32 forms an energy supply path.

The energy recovery controller 33 includes a second switch S2 and a second diode D2. The second switch S1 is turned on to perform an energy recovery operation such that the energy recovery controller 33 forms an energy recovery path.

The first inductor (L1) 34 is connected between the source capacitor 30 and the energy recovery controller 33. The second inductor (L2) 35 is connected between a common terminal of the energy supply controller 32 and the energy recovery controller 33 and the plasma display panel Cpanel.

The sustain pulse supply controller 36 includes a third switch S3 and a fourth switch S4. The third switch S3 and the fourth switch S4 are connected to a sustain voltage source (not illustrated) and a ground level voltage source (not illustrated), respectively. The third switch S3 and the fourth switch S4 are turned on to supply a sustain voltage Vcc and a ground level voltage VGND to the plasma display panel Cpanel.

Although the switches are simply illustrated in the form of a switch in the attached drawings, the switches illustrated in the attached drawings indicate a transistor including a body diode, unless otherwise defined.

An operation of the energy recovery circuit according to the first embodiment includes four stages.

It is assumed that a voltage Vp of the plasma display panel Cpanel is equal to 0V, and a charging voltage to the source capacitor Css is equal to Vcc/2.

In a first stage, the first switch S1 is turned on and the second, third, and fourth switches S2, S3 and S4 are turned off. As a result, the energy supply path passing through the source capacitor Css, the first switch S1, the first diode D1, and the second inductor L2 is formed.

At this time, the second inductor L2 and the plasma display panel Cpanel form a serial resonance circuit. Since the charging voltage to the source capacitor Css is equal to Vcc/2, the voltage Vp of the plasma display panel Cpanel rises to the voltage Vcc equal to two times the charging voltage of the source capacitor Css.

The energy recovery circuit according to the first embodiment uses one inductor, i.e., the second inductor L2 when supplying the charging voltage of the source capacitor Css to the plasma display panel Cpanel. Therefore, inductance in the case of supplying the energy to the plasma display panel Cpanel is small such that a strong discharge occurs.

In a second stage, the first switch S1 and the third switch S3 are turned on and the second switch S2 and the fourth switch S4 are turned off.

As a result, the voltage Vp of the plasma display panel Cpanel is equal to the sustain voltage Vcc. The moment the first stage is complete (i.e., the moment the voltage Vp of the plasma display panel Cpanel is equal to the sustain voltage Vcc using LC resonance), the sustain voltage source supplies the sustain voltage Vcc to the plasma display panel Cpanel and then the voltage Vp of the plasma display panel Cpanel is maintained at the sustain voltage Vcc for a predetermined duration of time.

In a third stage, the second switch S2 is turned on, and the first, third and fourth switches S1, S3 and S4 are turned off. As a result, the source capacitor Css is charged to the energy stored in the plasma display panel Cpanel and the voltage Vp of the plasma display panel Cpanel falls.

In the third stage, the energy recovery path passing through the plasma display panel Cpanel, the second inductor L2, the second diode D2, the second switch S2, the first inductor L1, and the source capacitor Css is formed.

The energy recovery circuit according to the first embodiment uses the plurality of inductors, i.e., the first inductor L1 and the second inductor L2 when recovering the energy from the plasma display panel Cpanel. Therefore, inductance of the case of recovering the energy from the plasma display panel Cpanel is more than inductance of the case of supplying the energy to the plasma display panel Cpanel, thereby increasing the energy recovery efficiency.

For example, when inductance of the first inductor L1 is equal to inductance of the second inductor L2, inductance in the energy recovery operation is two times inductance in the energy supply operation. Accordingly, time required to raise the Voltage Vp of the plasma display panel Cpanel to the sustain voltage in the energy supply operation is reduced such that the strong discharge occurs. Further, the inductance in the energy recovery operation increases such that the energy recovery efficiency increases. Of course, as the inductance in the second inductor L2 increases to be more than the inductance in the first inductor L1, the energy recovery efficiency further increases.

In a fourth stage, the second switch S2 and the fourth switch S4 are turned on and the first switch S1 and the third switch S3 are turned off. As a result, the voltage Vp of the plasma display panel Cpanel is equal to the ground level voltage VGND.

The moment the third stage is complete (i.e., the moment the voltage Vp of the plasma display panel Cpanel is equal to the ground level voltage VGND using LC resonance), the ground level voltage source supplies the ground level voltage VGND to the plasma display panel Cpanel and then the voltage Vp of the plasma display panel Cpanel is maintained at the ground level voltage VGND for a predetermined duration of time.

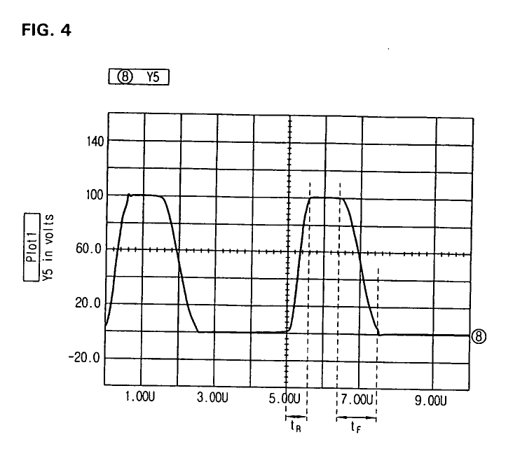

FIG. 4 illustrates a driving waveform generated by the energy recovery circuit of the plasma display apparatus according to the first embodiment.

As illustrated in FIG. 4, time required to supply the energy to the plasma display panel Cpanel, i.e., rising time tR is short, and time required to recover the energy from the plasma display panel Cpanel, i.e., falling time tF is two times the rising tR. In other words, the strong discharge occurs and the energy recovery efficiency increases.

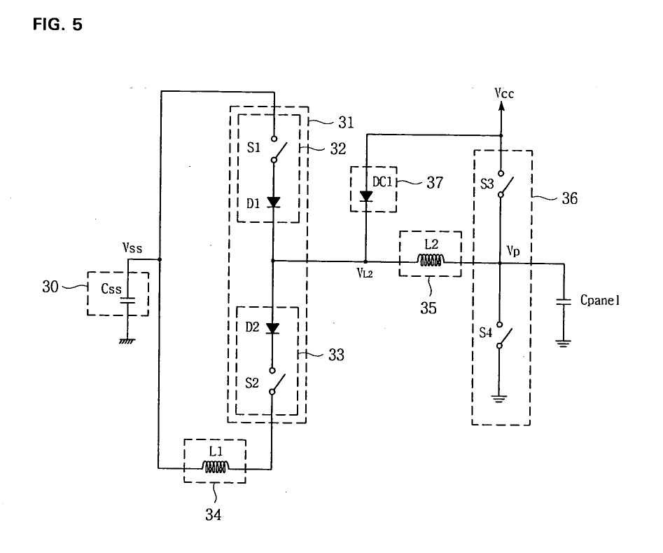

FIG. 5 illustrates an energy recovery circuit of a plasma display apparatus according to a second embodiment.

As illustrated in FIG. 5, the energy recovery circuit according to the second embodiment is substantially the same as the energy recovery circuit according to the first embodiment, except that a first clamping diode DC1 is installed between a common terminal of a second inductor L2 and a first diode D1 (or a second diode D2) and an application part of a sustain voltage Vcc.

The first clamping diode DC1 prevents the generation of unnecessary resonance of a voltage VL2 in one terminal of the second inductor L2 due to a voltage Vp of a plasma display panel Cpanel when the voltage Vp of the plasma display panel Cpanel reaches a sustain voltage Vcc and then a current flowing in the second inductor L2 is equal to 0.

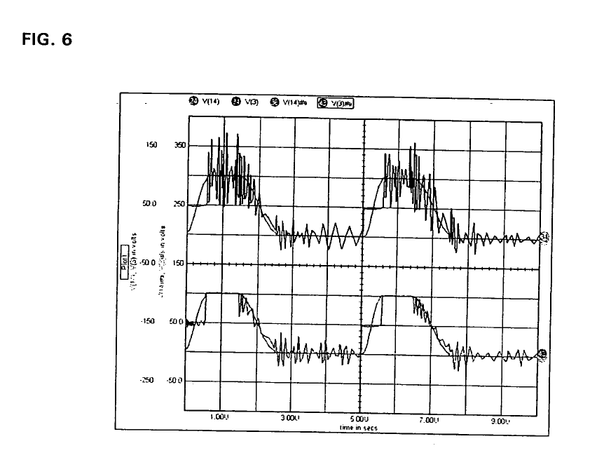

FIG. 6 illustrates a driving waveform generated by the energy recovery circuit of the plasma display apparatus according to the second embodiment.

An upward driving waveform in the driving waveform of FIG. 6 indicates an irregular state of the voltage VL2 in one terminal of the second inductor L2 in a case where there is no first clamping diode DC1. A downward driving waveform in the driving waveform of FIG. 6 indicates a regular state of the voltage VL2 in one terminal of the second inductor L2 in a case where there is the first clamping diode DC1.

As illustrated in FIG. 6, the first clamping diode DC1 greatly reduces the unnecessary resonance that may occur in a state where a third switch S3 is turned on (i.e., after supplying the sustain voltage).

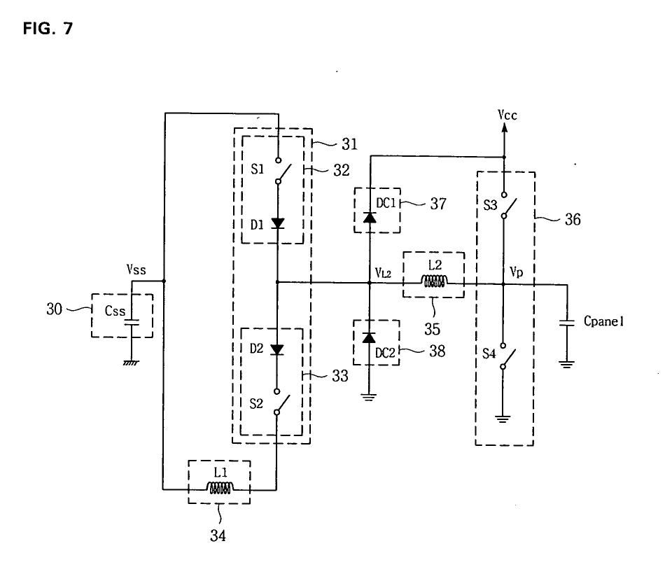

FIG. 7 illustrates an energy recovery circuit of a plasma display apparatus according to a third embodiment.

As illustrated in FIG. 7, the energy recovery circuit according to the third embodiment is substantially the same as the energy recovery circuit according to the second embodiment, except that a second clamping diode DC2 is installed between a common terminal of a second inductor L2 and a first diode D1 (or a second diode D2) and an application part of a ground level voltage.

The second clamping diode DC2 prevents the generation of unnecessary resonance of a voltage VL2 in one terminal of the second inductor L2 when the voltage Vp of the plasma display panel Cpanel reaches a ground level voltage and then a current flowing in the second inductor L2 is equal to 0.

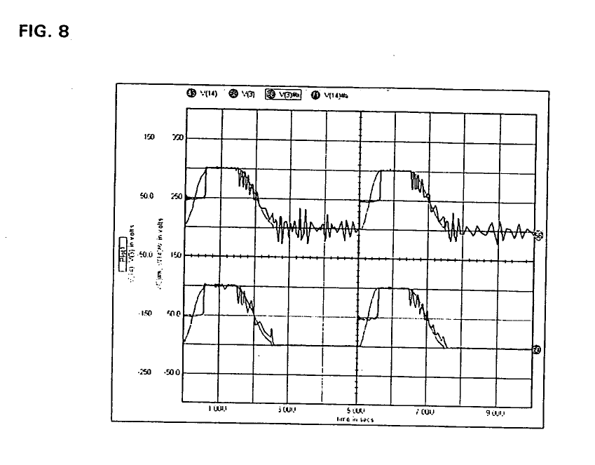

FIG. 8 illustrates a driving waveform generated by the energy recovery circuit of the plasma display apparatus according to the third embodiment.

An upward driving waveform in the driving waveform of FIG. 8 indicates an irregular state of the voltage VL2 in one terminal of the second inductor L2 in a case where there is no second clamping diode DC2. A downward driving waveform in the driving waveform of FIG. 8 indicates a regular state of the voltage VL2 in one terminal of the second inductor L2 in a case where there is the second clamping diode DC1.

As illustrated in FIG. 8, the second clamping diode DC2 greatly reduces the unnecessary resonance that may occur in a state where a fourth switch S4 is turned on (i.e., after supplying the ground level voltage).

As described above, in the plasma display apparatus according to the embodiments, since inductance in the case of recovering the energy from the plasma display panel is more than inductance in the case of supplying the energy to the plasma display panel, the energy recovery efficiency increases while the strong discharge occurs.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus, comprising:
a plasma display panel; and
an energy recovery circuit that supplies an energy to the plasma display panel and recovers an energy from the plasma display panel,
wherein inductance in an energy supply path for supplying the energy to the plasma display panel is less than inductance in an energy recovery path for recovering the energy from the plasma display panel.

2. The plasma display apparatus of claim 1, wherein the energy recovery circuit includes
a source capacitor charged to the energy recovered from the plasma display panel,
an energy supply controller forming the energy supply path for supplying the energy to the plasma display panel,
an energy recovery controller forming the energy recovery path for recovering the energy from the plasma display panel,
a first inductor connected between the energy recovery controller and the source capacitor, and
a second inductor connected between a common terminal of the energy supply controller and the energy recovery controller and the plasma display panel.

3. The plasma display apparatus of claim 2, wherein the energy supply path passes through the source capacitor, the energy supply controller, and the second inductor.

4. The plasma display apparatus of claim 2, wherein the energy recovery path passes through the second inductor, the energy recovery controller, the first inductor, and the source capacitor.

5. The plasma display apparatus of claim 2, wherein the energy recovery circuit further includes a first clamping diode connected between a common terminal of the second inductor and the energy supply controller and a sustain voltage source.

6. The plasma display apparatus of claim 5, wherein the energy recovery circuit further includes a second clamping diode connected between the common terminal of the second inductor and the energy supply controller and a ground level voltage source.

7. A plasma display apparatus, comprising:
a plasma display panel;
a source capacitor charged to an energy recovered from the plasma display panel;
an energy supply controller forming an energy supply path for supplying an energy to the plasma display panel;
an energy recovery controller forming an energy recovery path for recovering an energy from the plasma display panel;
a first inductor connected between the energy recovery controller and the source capacitor; and
a second inductor connected between a common terminal of the energy supply controller and the energy recovery controller and the plasma display panel.

8. The plasma display apparatus of claim 7, wherein the energy supply controller includes a first switch and a first diode, and the energy recovery controller includes a second switch and a second diode.

9. The plasma display apparatus of claim 7, wherein the energy supply path passes through the source capacitor, the energy supply controller, and the second inductor.

10. The plasma display apparatus of claim 7, wherein the energy recovery path passes through the second inductor, the energy recovery controller, the first inductor, and the source capacitor.

11. The plasma display apparatus of claim 7, further comprising a first clamping diode connected between a common terminal of the second inductor and the energy supply controller and a sustain voltage source.

12. The plasma display apparatus of claim 11, further comprising a second clamping diode connected between the common terminal of the second inductor and the energy supply controller and a ground level voltage source.

13. A plasma display apparatus, comprising:
a plasma display panel; and
an energy recovery circuit that supplies an energy to the plasma display panel using one inductor and recovers an energy from the plasma display panel using a plurality of inductors.

14. The plasma display apparatus of claim 13, wherein an energy recovery path for recovering the energy from the plasma display panel includes a first inductor and a second inductor, and an energy supply path for supplying the energy to the plasma display panel includes the second inductor.

15. The plasma display apparatus of claim 14, wherein one terminal of the second inductor is connected to the plasma display panel, and
the energy recovery circuit includes a first clamping diode connected between the other terminal of the second inductor and a sustain voltage source.

16. The plasma display apparatus of claim 15, the energy recovery circuit further includes a second clamping diode connected between the other terminal of the second inductor and a ground level voltage source.
